(19) United States
(12) Patent Application Publication
(10) Pub. No.: US 2015/0379522 A1
(43) Pub. Date: Dec. 31, 2015

(54) MODIFIABLE SHARING OF RECEIVED CONTENT

(71) Applicant: Prolifiq Software Inc., Beaverton, OR (US)

(72) Inventors: Hemingway Huynh, Salem, OR (US); Anh Huynh, Tigard, OR (US); Isabella Wong, Bellevue, WA (US); Jeffrey Michael Farnsworth, Portland, OR (US)

(21) Appl. No.: 14/752,654

(22) Filed: Jun. 26, 2015

Related U.S. Application Data
(60) Provisional application No. 62/018,420, filed on Jun. 27, 2014.
(60) Provisional application No. 62/066,325, filed on Oct. 20, 2014.

(51) Int. Cl. G06Q 30/00

(52) U.S. Cl. CPC G06Q 30/018

(57) ABSTRACT

Embodiments described herein are directed to methods, apparatuses, systems, and computer-readable media for a content provisioning system (“CPS”) publishing modified content to users. A content provider may provide content to the CPS, for example using a notification that content is available for download. The CPS may convert the content, which may be viewed by a publisher. The publisher may share received content with recipients. The publisher may select recipients to receive the content and send a request to share the content to the CPS. The publisher may choose to modify the content before requesting that it be shared. The publisher may make modifications to the content on the publisher's device. The CPS may perform modifications to the content before sharing the modified content with selected professionals. Permissions may be associated with the content, which may be consulted before allowing modification and/or sharing. Other embodiments may be described and/or claimed.

### CROSS REFERENCE TO RELATED APPLICATIONS

This application claims the benefit of: 1) U.S. Provisional Application No. 62/018,420, filed Jun. 27, 2014, and entitled “MODIFIABLE SHARING OF RECEIVED CONTENT” and 2) U.S. Provisional Application No. 62/066,325, filed Oct. 20, 2014, and entitled “MODIFIABLE SHARING OF RECEIVED CONTENT”. Both applications are incorporated herein by reference in their entirety.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Professionals, such as physicians, service providers, and other information workers are frequently provided with information that is relevant to their practice from content providers (such as equipment or drug manufacturers or resellers). The content providers may seek to provide different types of information, such as text-based, image-based, video-based, sound-based, or other information, to these professionals. This content may occasionally be used by intermediary parties, such as representatives of the content providers or of other services, to discuss services, drugs, equipment, etc. with the professionals. However, content providers may not always provide content in a consistent manner, which may frustrate the ability of the intermediary parties to share the content. Further, intermediary parties may determine that the provided content is not completely applicable to a given professional. This may frustrate the intermediaries' abilities to utilize the content in their efforts to work with professionals.

### DETAILED DESCRIPTION

Embodiments will be readily understood by the following detailed description in conjunction with the accompanying drawings. To facilitate this description, like reference numerals designate like structural elements. Embodiments are illustrated by way of example, and not by way of limitation, in the Figs. of the accompanying drawings.

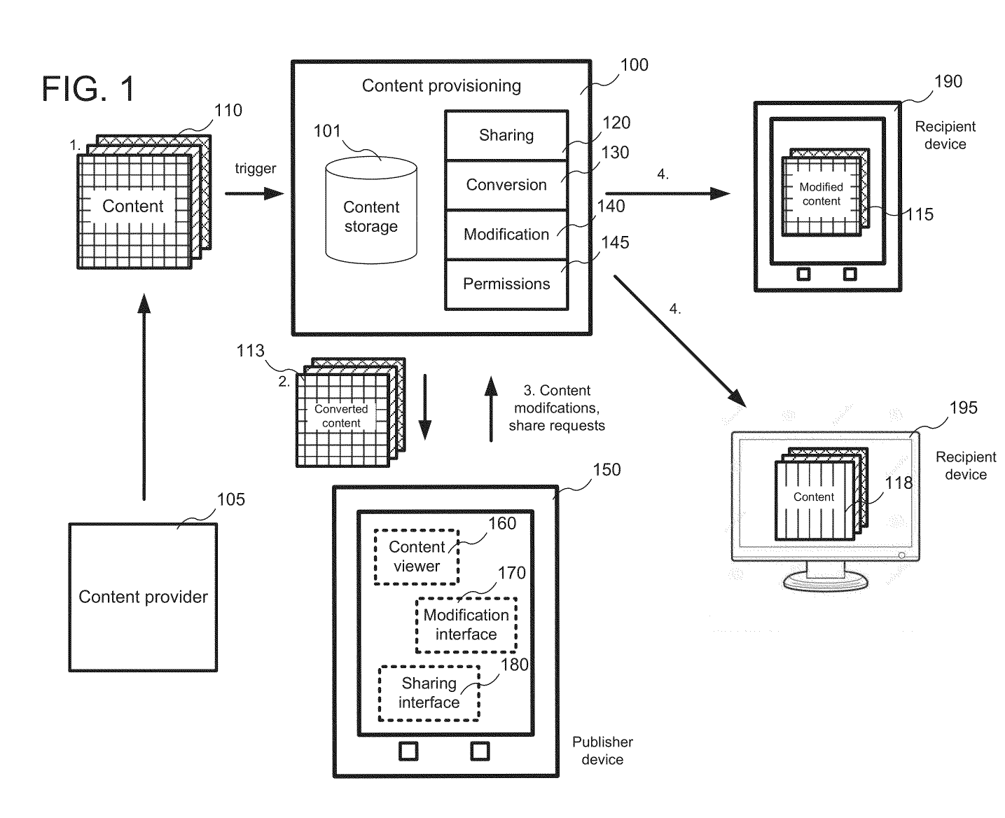

FIG. 1 illustrates an arrangement for sharing modified content to users, in accordance with various embodiments.

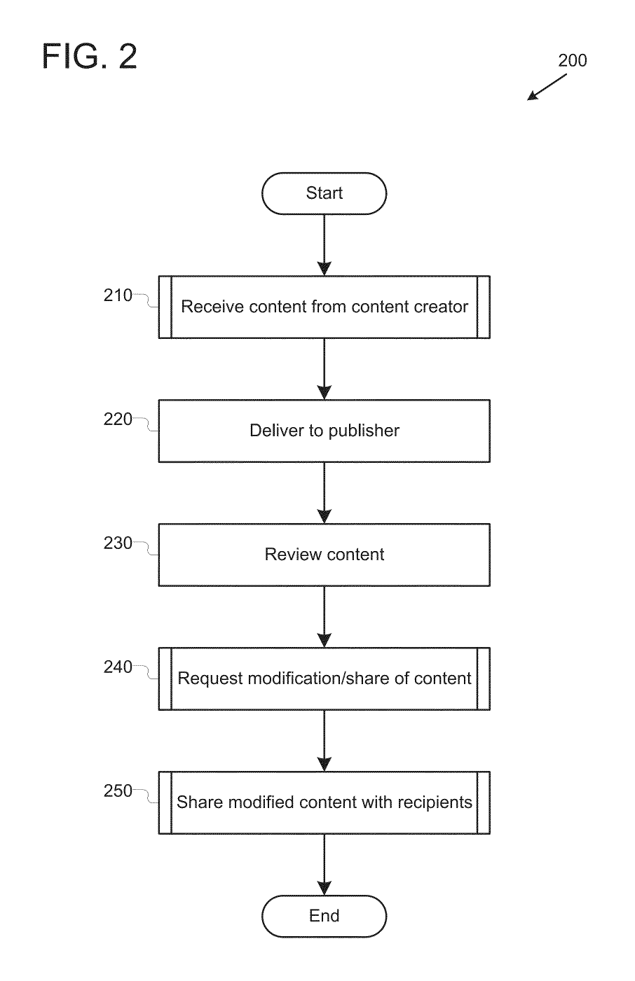

FIG. 2 illustrates an example process for modifying and sharing content, in accordance with various embodiments.

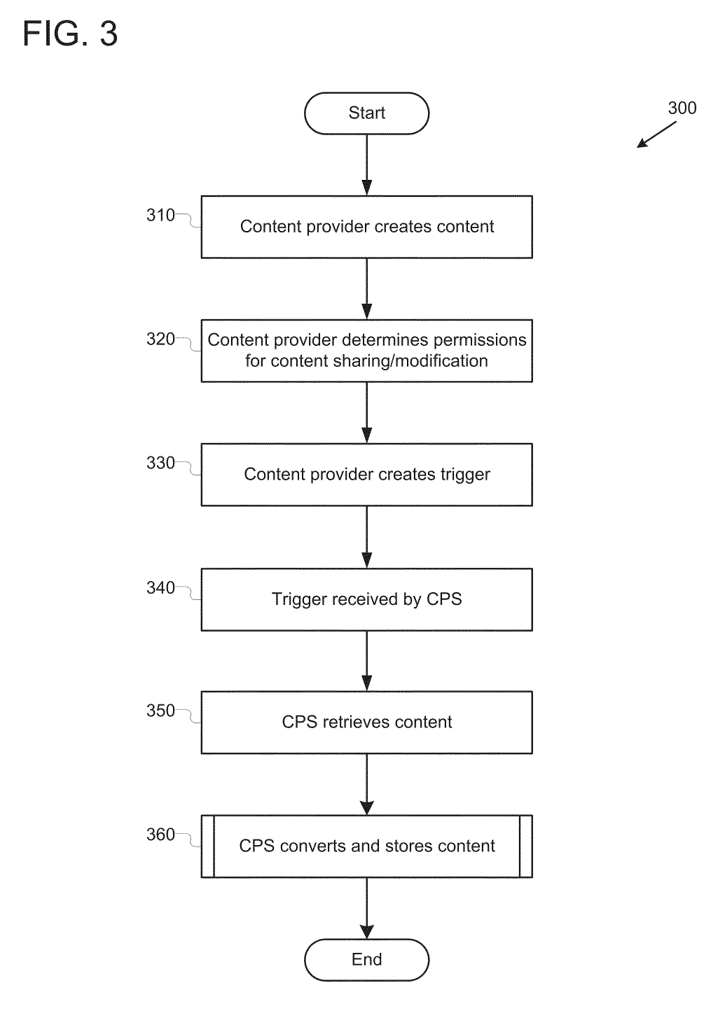

FIG. 3 illustrates an example process for a content provisioning system to receive content from a content provider, in accordance with various embodiments.

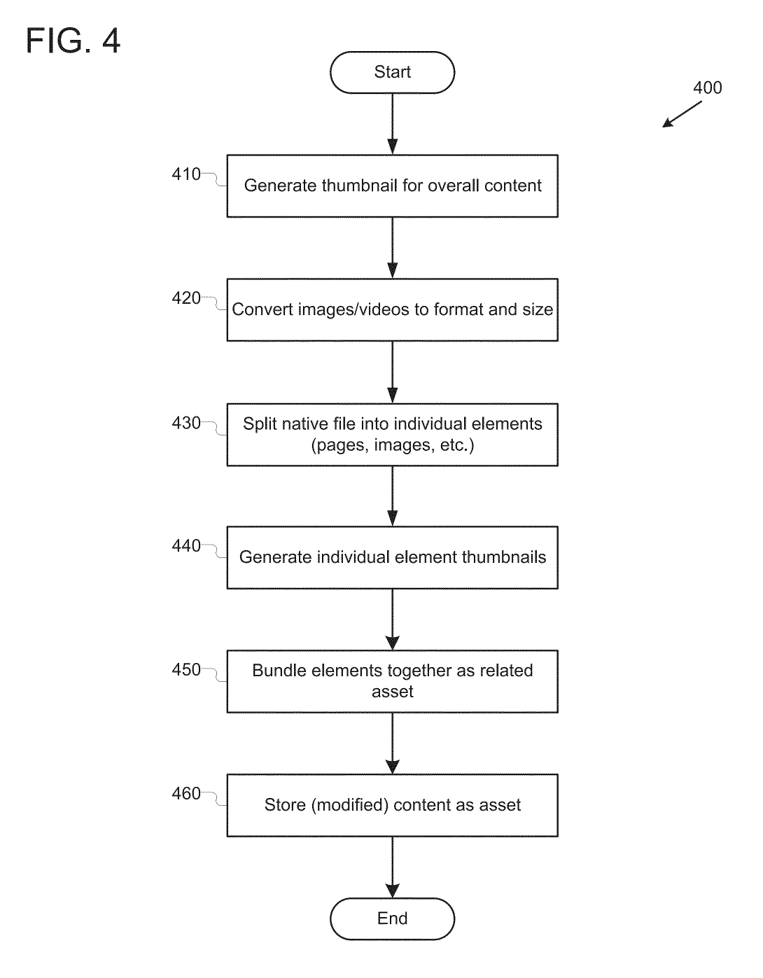

FIG. 4 illustrates an example process for a publisher device to convert and store content, in accordance with various embodiments.

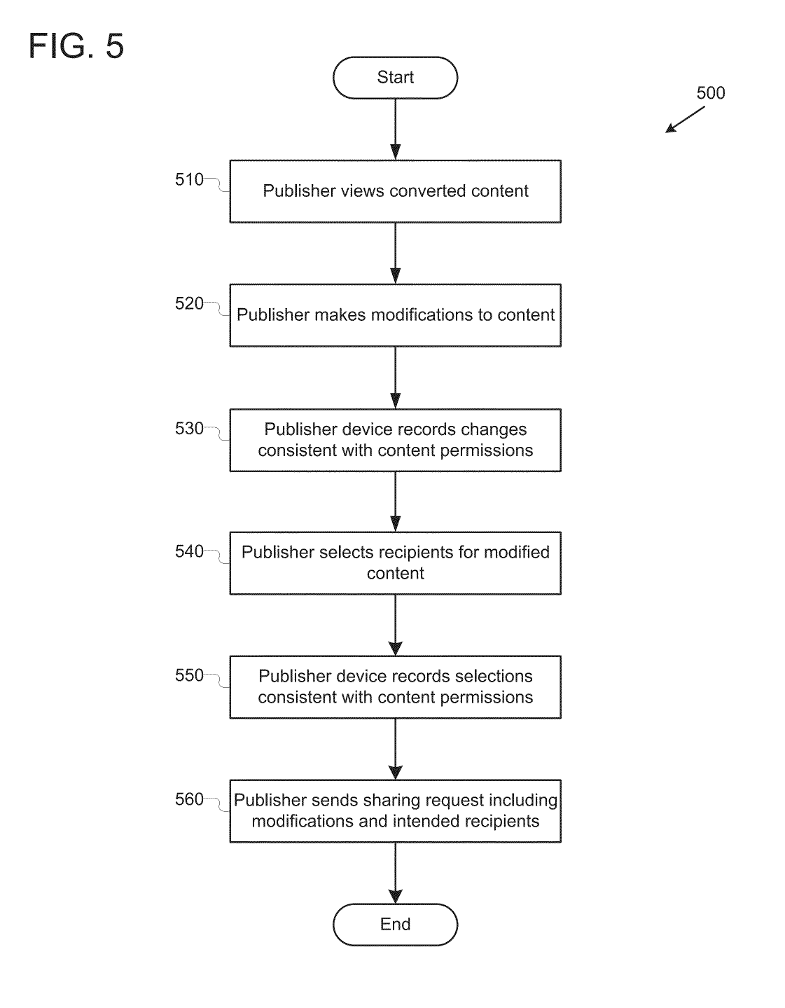

FIG. 5 illustrates an example process for a publisher device to request modification and/or sharing of content from the content provisioning system, in accordance with various embodiments.

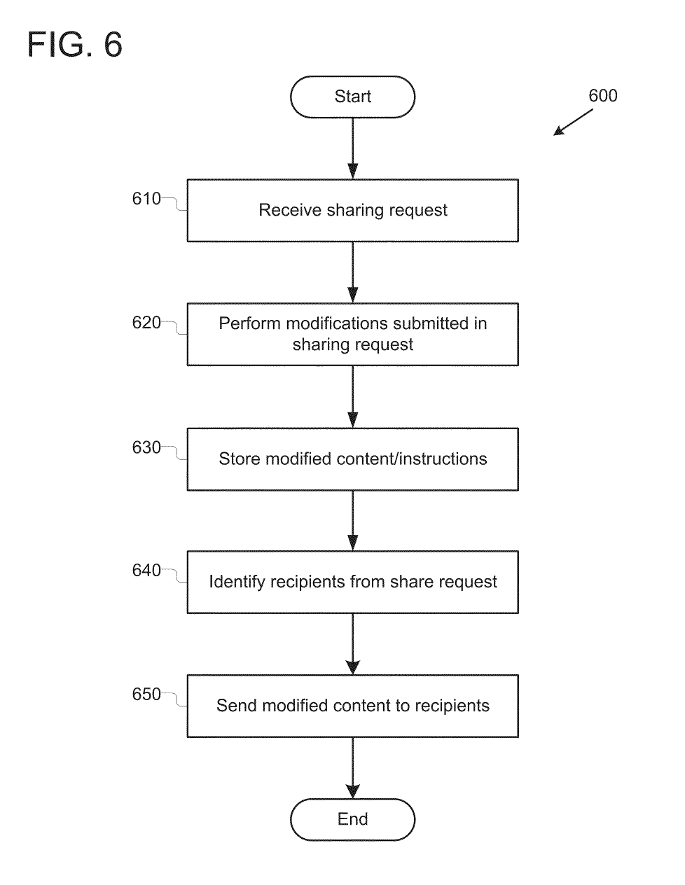

FIG. 6 illustrates a first example process for the content provisioning system to share stored content, in accordance with various embodiments.

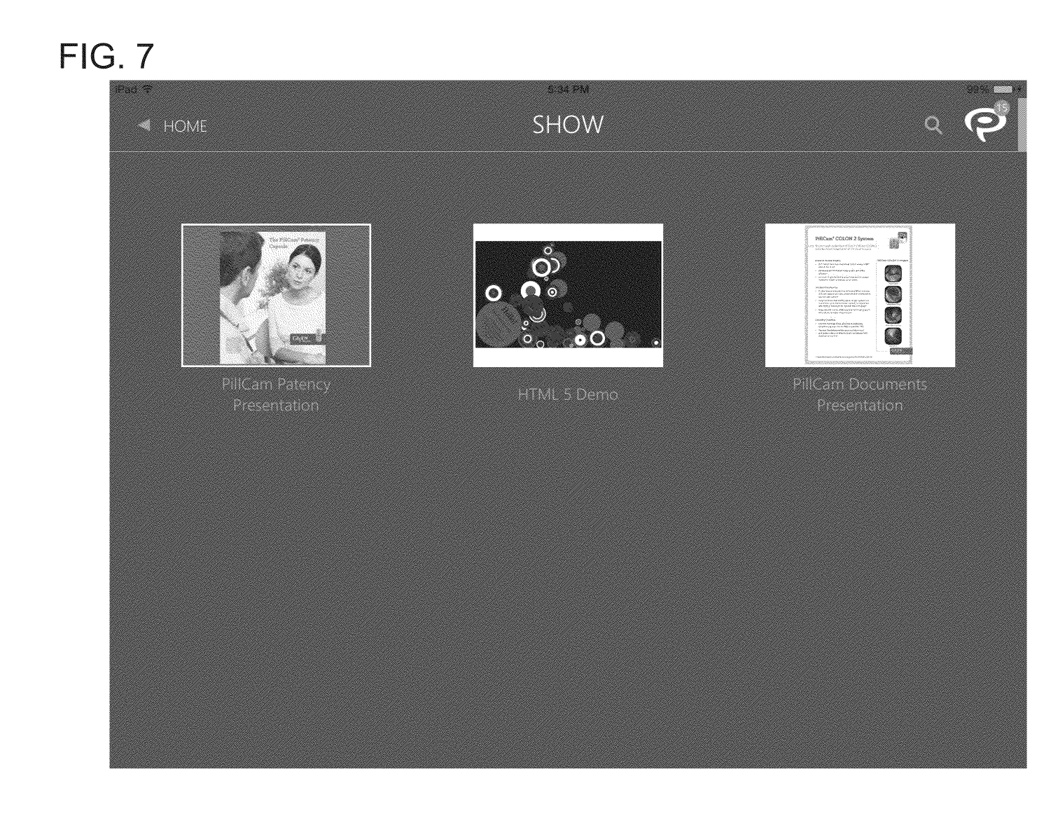

FIGS. 7-14 illustrate example interfaces of a publisher device used to perform some of the techniques described herein, in accordance with various embodiments.

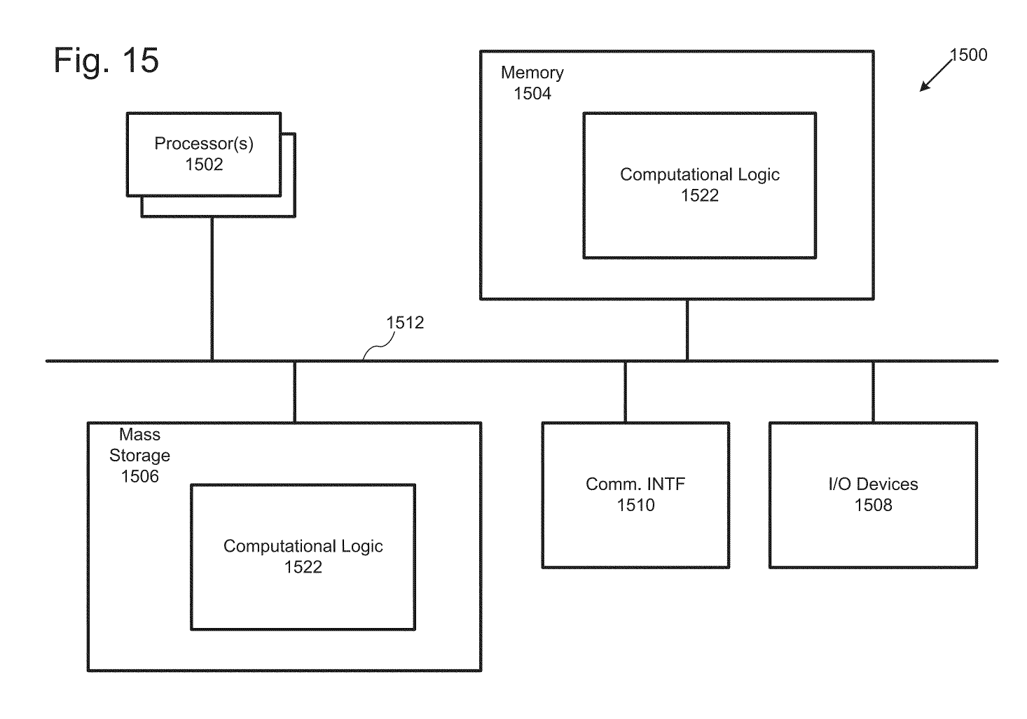

FIG. 15 illustrates an example computing environment suitable for practicing various aspects of the present disclosure in accordance with various embodiments.

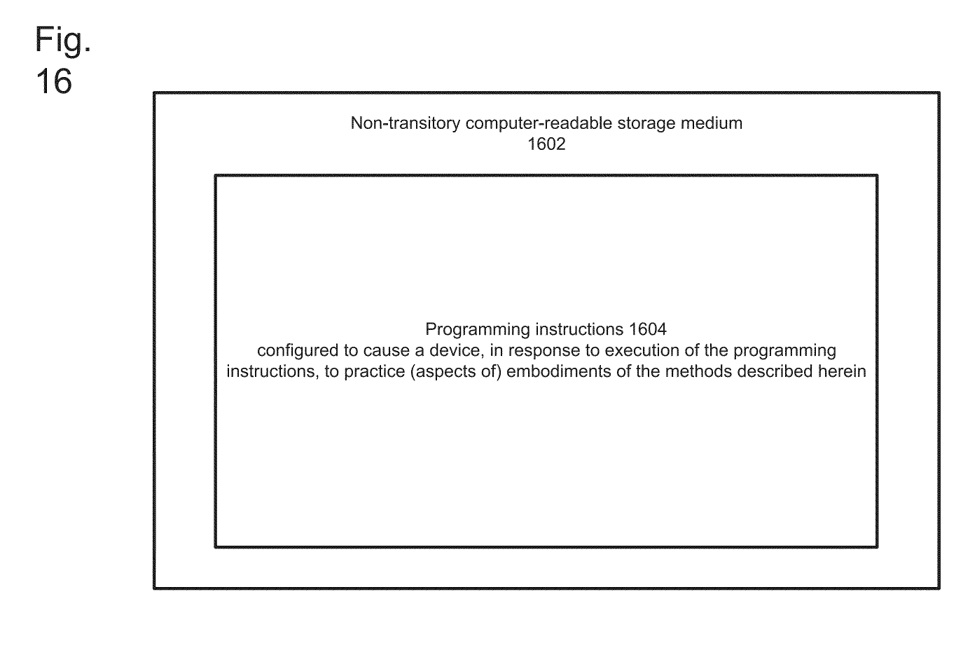

FIG. 16 illustrates an example storage medium with instructions configured to enable an apparatus to practice various aspects of the present disclosure in accordance with various embodiments.

### DETAILED DESCRIPTION

Embodiments described herein are directed to, for example, methods, apparatuses, systems, and computer-readable media for publishing modified content to users, such as knowledge professionals. In various embodiments, a content provider may provide content to a content provisioning system (“CPS”). In some embodiments, the CPS may be configured to download the content in response to a notification from the content provider that the content is available for download. The CPS may then convert the content so that it may be downloaded and viewed by a publisher, such as a representative of the content provider or other party. In various embodiments, the publisher may have a device, such as a desktop computer, laptop computer, smartphone, tablet, etc. which includes a viewing application that can view the converted content. In various embodiments, by providing converted content, the CPS may better ensure that the content is viewable by the publisher in a controlled, consistent environment.

In various embodiments, a publisher may also be facilitated in sharing received content with recipients, such as professionals, thus acting, in some scenarios, as publisher of the content. In addition to being able to show the content on the publisher's device, the publisher may select recipients to receive the content. The publisher may then send a request to share the content to the CPS, which may then share the content with professionals, such as using email, streaming media, FTP, or other content and/or file transmission protocols. In other embodiments, the publisher may send a link, such as through an email, instant message, or social media service, which may be utilized by a recipient to download shared content. In yet another embodiment, content may be sent as a bundle of assets that are sent directly to a printer (not illustrated).

In some embodiments the publisher may additionally choose to modify the content before requesting that it be shared. In some embodiments, the publisher may make modifications to the content on the publisher's device. Indications of these modifications may be sent to the CPS along with the sharing request. The CPS may then perform modifications to the content (and optionally store the modified content) before sharing the modified content with selected professionals. Additionally, in various embodiments, one or more permissions may be associated with the content. These permissions may be consulted before allowing modification and/or sharing, and may limit modifications and/or sharing that can be performed on the content.

It may be noted that, while embodiments described herein discuss sharing of data to knowledge professionals, in some embodiments, sharing may be performed to recipients who are a service or a system. For example, sharing may be made to a system that may print, electronically publish, or otherwise make available, published information.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an arrangement for sharing modified content to users is illustrated in accordance with various embodiments. Although particular details of content modification and sharing are discussed below, FIG. 1 illustrates an example of a basic work flow where four types of entities (a content provider 105 a content provisioning system 100 (“CPS 100”), one or more publisher devices 150, and recipient devices 190 and 195) may perform high-level interactions. In the first interaction, content 110 may be provided to the CPS 100 from a content provider. In the second interaction, content 110 which has been converted for viewing on a publisher device may be provided to the publisher device by the CPS 100 for review and for possible modification and/or sharing. Next, at the third interaction, the publisher device 150 may provide content modification instructions and/or sharing requests to the CPS 100 so that the CPS 100 may modify the converted content and share the modified converted content (110 and/or 115) with recipients. In the fourth interaction, the modified content may be shared with recipient devices (190 and/or 195), as shown. Particular examples of these interactions, and the entities which may perform them, are described herein.

As shown in FIG. 1, a content provider 105 may provide content 110 for sharing by a publisher, such as, for example, a representative of the content provider 105. For example, the content 110 may be provided by one or more pharmaceutical manufacturer content providers 105 for provisioning to sales representatives, acting as publishers; the sales representatives may then facilitate sharing of the data to physicians or other medical professionals. It may be noted that the content 11—is illustrated in FIG. 1 as a stack of differently-patterned tiles; this configuration is used for illustrative effect only and is not meant to imply any limitation on content, modules, or techniques described herein.

Content providers 105 may, in various embodiments, utilize various technologies for providing content to the CPS 100. For example, in some embodiments, a content provider 105 may generate one or more feeds that provides updated content, such as an RSS or other updatable feed technology. Content may, in various embodiments, be provided as documents and/or feeds that may be presented in various formats, such as, for example XML, plain text, power point or other presentation format, PDFs, HTML, HTML5, Microsoft Word or other word processing format, links to web pages, image formats, etc. In some embodiments, the content providers may provide one or more files that may be uploaded directly to (or downloaded by) a content storage 101 within the functionality of and/or under the control of the CPS 100. For example, in some embodiments, the content provider 105 may provide to the CPS 100 a trigger that causes the CPS 100 to initiate a retrieval of the content. This retrieval by the CPS 100 may later be followed by the CPS 100 itself providing the content 110 to the publisher. In other embodiments, the content 110 may be directly provided to the CPS 100, such as through email, FTP, or other protocols.

The CPS 100 itself may, in various embodiments, include one or more modules or subsystems which may be configured to perform activities described herein. For example, in various embodiments, once the CPS 100 receives the content 110 from the content provider 105, the content 110 may be stored in content storage 101. In various embodiments, this content storage 101 may be local to the CPS 100 or remote from the CPS 100, such as through wired or wireless networking, implementation in an online remote cloud, or via a wide-area network, such as the Internet. In various embodiments, the content storage 101 may include various forms of storage as understood by those or ordinary skill in the art and may reside in one or more physical locations. In various embodiments, the content storage 101 may store content 110 as originally provided to the CPS 100, and/or may store content 110 that has been converted for storing and/or sharing, as described herein. In various embodiments, the content storage 101 may also store one or more modification instructions describing modifications that are to be performed on content 110 (and/or a portion of content 110) before it is shared, as described herein.

In various embodiments, the CPS 100 may include a conversion module 130, which may be configured to receive the content from the content provider 105 and convert the content 110 into one or more formats that may be read by a publisher and/or recipient. For example in FIG. 1, converted content 113 is illustrated as being delivered to the publisher device 105, which is represented as a tablet; in various embodiments, the publisher device may take various forms, including laptop or desktop computers, mobile devices, smart phones, tablet computers, wearable computing devices, etc. In various embodiments, such converted content 113 may be stored by the content storage 101 of the CPS 100 for later sharing. In various embodiments, by converting the content 110 to converted content 113, the conversion module 130 of the CPS 100 may better facilitate easy sharing of the content 110 regardless of which format in which it was originally delivered. Conversion may also facilitate the use of additional controls, such as permissions which restrict modification and/or sharing of the content 110, by better ensuring that stored content is of a consistent form, or by restricting which recipients may receive content. Additionally, in some embodiments the conversion module 130 may allow the content provider 105 to restrict viewing of content to dedicated, protected modules or applications at a publisher and/or recipient device, further facilitating control of the content 110 as it is shared. For example, in the illustration of FIG. 1, the publisher device 150 may receive converted content 113 from the CPS 100 and may provide it for viewing by the publisher in a content viewer module 160 of the publisher device 150. From there, it may, in various embodiments, be modified and/or shared with recipients, as described herein, in a controlled and trusted manner. Similarly, because use of the conversion module 130 to convert the content 110 may facilitate the publisher in trusting that shared converted content 113 may only be viewable by recipients that have a trusted content viewer of their own (not illustrated).

In various embodiments, the content viewer 160 may also facilitate recording of viewing by publishers or recipients on a per transaction basis. Thus, for example, as a recipient views a piece of content (whether modified or not modified), the content viewer 160 may record particular pages or slides that are viewed, particular links that are selected, etc. In various embodiments, the content viewer 160 may record for how long a time particular portions of the content are viewed, as well. For example if the recipient watched the first 2 minutes of a 6 minute streaming video, this information may be collected by the content viewer.

In some embodiments, the publisher may utilize the content viewer 160 to show content directly to recipients, rather than request later sharing of content. For example, the publisher may show the converted content 113, on the publisher device 150, to a knowledge professional. In various embodiments, the content viewer 160 may be configured to receive notifications of an opinion of the content. For example, the content viewer 160 may contain one or more user interface elements for the publisher to use to indicate whether the converted content 113 was viewed favorably or unfavorably by a recipient to whom the publisher showed the content on the publisher device 150. These ratings may be sent to the CPS 100 and may be associated with the content 110 such that information regarding the favorability of particular elements of the content 110 may be viewed at a later date.

In various embodiments, the CPS 100 may also include a sharing module 120, which may be configured to share content 110 that has been provisioned to the CPS 100 from the content provider 105. In various embodiments, the sharing module 120 may be configured to share content to one or more recipients (such as knowledge professionals) based on a sharing request from a publisher device 150 (such as a device of a representative of the content provider), as illustrated. The sharing module 120 may be configured to respond to the request by sending the content to one or more recipients. In various embodiments, the publisher device 150 may be configure to include a sharing interface 180, which itself may be configured to facilitate selection of one or more recipients and to request the sharing of the content 110 with the selected recipients. In various embodiments, the sharing interface 180 of the publisher device may directly interoperate with the sharing module 120 of the CPS 100 (such as through a network). In other embodiments, the sharing interface 180 of the publisher device may be configured to provide requests for sharing to the CPS 100, but may not directly interface with the sharing module 120 of the CPS 100 itself.

In various embodiments, the sharing module 120 may be configured to share the content with various electrical or electronic computing devices, such as a tablet computer, e-book, or desktop computer, as illustrated, as well as other devices, such as smartphones, laptop computers, terminals, PDAs, and/or other devices. In various embodiments, the sharing module 120 may be configured to share the content in various manners, as may be understood. In some embodiments, the sharing module 120 may be configured to share the content with a dedicated application (not illustrated) on a recipient device (such as recipient devices 190 or 195). In other embodiments, the sharing module 120 may be configured to share content in a non-dedicated manner, such as using email or another protocol, as may be understood.

In various embodiments, the CPS 100 may also include a modification module 140, which may be configured to receive modification instructions, from approved/vetted devices or systems such as a publisher device 150, as illustrated. In various embodiments, the modification module 130 may be configured to perform one or more modifications to a piece of content based on modification instructions that may be received from the publisher device 150. In some embodiments, the publisher device may include a modification interface 170, where a publisher may perform various modifications to the content 110. In various embodiments, the modifications may include various types of modification, such as may be performed in word processing applications, presentation applications, photo-editing applications, etc. Such modifications may include, but are not limited to, removal of portions of content, including text, images, audio, video; modification of text, images, audio, data, or other types of content; redaction of one or more portions of content; application of one or more filters to content, etc. In various embodiments as well, modification may performed at different levels of granularity. Thus, in some embodiments, individual word or lines may be modified, deleted, amended, etc., while in other embodiments, larger passages, such as paragraphs, pages, or entire documents, may be modified. In the example of FIG. 1, the modified content 115 shared to the recipient device tablet 190 (in the upper right corner of FIG. 1) has had a page removed, while data on the front page of the modified content 118 has been modified before sharing to the recipient device desktop computer 195 illustrated toward the lower right corner of FIG. 1. In other embodiments, other forms of modification may be contemplated. In some embodiments, modification may include combining content from multiple sources or documents. Thus, in some embodiments, content from one documents (e.g. a word processing document, PDF, presentation, etc.) may be added to another source or content from two or more sources may be combined to create a new content document.

The modification interface 170 of the publisher device may be configured to, after receiving the modifications, record instructions for re-creating the modifications and may transmit these modifications instructions to the modification module 140 of the CPS 100. The modification module of the CPS 100 may thereafter be configured to perform the modifications immediately on the stored content and to store the modified content on the content storage for later publication. In other embodiments, the modification module 140 may be configured to perform modifications when sharing content to a recipient device, such as to reduce storage needs for modified content. In various embodiments, the modification interface 170 of the publisher device may directly interoperate with the modification module 140 of the CPS 100 (such as through a network). In other embodiments, the modification interface 170 of the publisher device may be configured to provide modification instructions to the CPS 100, but may not directly interface with the modification module 140 of the CPS 100 itself In various embodiments, modifications that are made to the content 110 may be preserved and viewable at a later date at the publisher device 150, or at another publisher device by the same publisher. In this manner, modification history may be maintained across multiple devices and at different points in time.

In various embodiments, the CPS 100 may also include a permissions module 145, which may be configured to receive and maintain permissions for modification and/or sharing of the content 110 provided to the CPS 100. In various embodiments, the permissions module 145 may be configured to respond to queries from other modules, such as the sharing module 120 or the modification module 140, to determine if particular sharing or modification activities are permitted by the content provider.

For example, in various embodiments, the permission module 145 may receive permissions from the content provider. In various embodiments, permissions may include restrictions on the sharing of content. For example a publisher of a piece of content 110 may be restricted to sharing the content to only particular recipients; in other embodiments, permissions may not allow sharing at all. In some embodiments, permissions may restrict the amount of time that a piece of content 110 may be allowed to be viewed by recipients (such as knowledge professionals and/or publishers) before it must be deleted. In yet other embodiments, the permissions may restrict in what form the content 110 may be shared, such as in an uneditable fashion or in a form where information cannot be easily pulled from the content (such as using a PDF where text cannot be selected).

In various embodiments, the permissions may include restrictions on modifications that may be made on the content 110, such as by the publisher, a recipient, or both. For example in some embodiments, the CPS 100 may receive permissions that prevent any modification of content. In other embodiments, the CPS 100 may receive permissions that require particular modifications be made to the content (such as removal or redactions to particular portions of the content) before the content may be shared. In other embodiments, the CPS 100 may receive permissions from the content provider that restrict modification to particular types of modifications, such as reordering of content vs. removal of portions of content. In various embodiments, other permissions, relating to sharing, modification, or other activities, maybe received and/or maintained by the CPS 100 and the permission module. For example, in some embodiments, permissions associated with a particular piece of content may require that certain portions of the content may not be removed or may not be modified. In other embodiments, permissions may require that a portion of content always be included if other portions are included. For example, a permission may require that, if pages 1 or 2 of a document are included, that page 7 must be included. In various embodiments, utilization of such permissions may help ensure that important information, disclaimers, competitive analysis, etc. are included in content when it is published. In other embodiments, permissions may require that if any content from a document is included in a modified document that the entire original document be included (e.g., if a single page from a 10-page presentation is included, all 10 pages must be included). In other embodiments, permissions may require that if content is included in a particular document that it be maintained in order and/or that no content be introduced between portions of the document.

The permissions may be associated with a particular piece of content 110 or with multiple sets of content 110. For example, if content is provided in a period fashion, such as from a feed, the permissions module of the CPS 100 may receive blanket permissions from the content provider for all content from the feed, and/or may receive particularized permissions for specific pieces of content provided by the content provider. In some embodiments, the CPS 100 may receive permissions for portions of a piece of content. For example, if a piece of content has a data chart with particularly sensitive data on it, permissions for the content may require that, for the content to be shared, the sensitive data (or a page or portion in which the sensitive data is found) be removed or redacted.

Referring now to FIG. 2, an example process 200 for modifying and sharing content is illustrated in accordance with various embodiments. While FIG. 2 illustrates particular example operations, in various embodiments, the process may include additional operations, omit illustrated operations, and/or combine illustrated operations. The process may begin at operation 210 when the CPS 100 may receive content 110 from the content creator. Particular examples of operation 210 may be described below with reference to FIG. 3. Next, at operation 220, the CPS 100 may deliver the content 110 to the publisher. In various embodiments, the CPS 100 may deliver converted content 113 to the publisher device, as discussed above. In various embodiments, the converted content 113 may be delivered along with one or more indications of permissions associated with the content 110, in order to better protect usage of the content 110 according to the desires of the content provider. In various embodiments, the content viewer 160 may display one or more permissions during viewing of the converted content 113, such that the publisher may better understand which permissions are available.

Next, at operation 230, the publisher may review the converted content 113, such as by using the content viewer 160 of the publisher device. In various embodiments, during this operation, the publisher may elect to allow other recipients, or other entities, to view the converted content 113 on the publisher device as well. However, at operation 240, the publisher may request modification and/or sharing of the content 110. Particular examples of operation 240 may be described below with reference to FIG. 5. After the request, at operation 250 the CPS 100 may then share the modified content with one or more recipients. Particular examples of operation 250 may be described below with reference to FIG. 6. After this operation, the process may then end.

Referring now to FIG. 3, an example process 300 for the CPS 100 to receive content from a content provider is illustrated in accordance with various embodiments. While FIG. 3 illustrates particular example operations, in various embodiments, the process may include additional operations, omit illustrated operations, and/or combine illustrated operations. In various embodiments, process 300 may include various implementations of operation 210 of process 200 of FIG. 2. The process may begin at operation 310, where the content provider creates content 110. As discussed above, in various embodiments, the content 110 created by the content creator may include various types of content, including text, images, video, audio, presentations, combinations thereof, or other types of content. At the operation 320, the content provider may determine one or more permissions for the content 110. As discussed above, these permissions may include restrictions and/or requirements on usage of the content. In particular the permissions may, in various embodiments, be related to modification and/or sharing of the content.

At operation 330, the content provider may create a trigger signaling the CPS 100 to initiate provisioning of the content. In various embodiments, a trigger may include an object or other data structure associated with the content 110. In various embodiments, such a data structure or object may be sent to the CPS 100 via a messaging format which may be configured to provide content 110 and/or information regarding content 110. In various embodiments, the trigger may include one or more descriptions of the content, including, but not limited to, content type, content name, content size, content location (for example, on a network and/or file system), etc. In various embodiments, the messaging format may provide for triggers and other messages to be received and stored for asynchronous processing. In various embodiments, the messaging format may also include information regarding the content provider or other entity sending the message. Thus, in various embodiments, messages send via the messaging format may be validated, such as for authenticity or authorization, and then stored for subsequent processing. In other embodiments, the messaging format may support validation of its fields, content, etc.

Next, at operation 340, the trigger may be received by the CPS 100, such as by receipt of a message including the trigger. As mentioned above, in various embodiments, receipt of the trigger may include validation of the message in which the trigger was sent, as well as storage of the message for subsequent and/or asynchronous processing. At operation 350, the CPS 100 may retrieve the content 110. In various embodiments, the trigger may include descriptions and other information for multiple pieces of content 110, and may facilitate the download of multiple pieces of content by the CPS 100. In other embodiments, the trigger may itself include pieces of content 110. In various embodiments, the trigger may also include access information for the content, such as login and/or authentication information which may be used to access remotely stored content 110. After retrieval of the content 110, at operation 360, the CPS 100 may convert the content 110 for storage and later delivery and/or sharing, as described above. In various embodiments, the CPS 100 may not convert the content immediately, but may instead perform conversion when sending the content to a publisher or a recipient. Particular examples of operation 360 may be described below with reference to FIG. 4. The process may then end.

It may be noted that, while in the description above, the CPS 100 is described as retrieving content in response to receipt of a trigger, and specifically a trigger sent via a messaging format, in other embodiments, other methods of provisioning content to the CPS 100 may be used. For example, in some embodiments, the content may be sent directly to the CPS 100 from the content provider (such as using email, FTP, or other protocols), may be placed at a known networked storage location, and/or may be released to the CPS 100 as part of a content feed. In other embodiments, the CPS 100 may regularly poll a server, or check a feed, for new content. In other embodiments, other techniques for sharing content may be used.

Referring now to FIG. 4, an example process 400 for a publisher device to convert and store content is illustrated in accordance with various embodiments. While FIG. 4 illustrates particular example operations, in various embodiments, the process may include additional operations, omit illustrated operations, and/or combine illustrated operations. The process may begin at operation 410, where the conversion module 140 may generate one or more thumbnails for the content 110. In various embodiments the thumbnails may be used, such as by the content viewer 180 of the publisher device 150, to allow a publisher to select content for viewing, presentation, and/or modification. Next, at operation 420, the conversion module 140 may convert images and/or videos to one or more consistent formats and sizes. In various embodiments, these formats and/or sizes may be selected to provide for space savings, such as on the content storage 101, the publisher device 150, or one or more recipient devices. In some embodiments the formats and/or sizes may be selected to provide for easier modification and/or viewing, such as by reducing the amount of processing used during later manipulation of the converted content 113. In various embodiments, at operation 420, video may be transcoded to produce one or more selected formats.

Next, at operation 430, the content file (which may have been converted at operation 420) may be split into multiple elements. In various embodiments, the type and/or granularity of these elements may change based on the type of content 110 that was provided to the conversion module 140. For example, a piece of PDF content may be divided into individual pages, while a Power Point presentation may be divided into slides. By contrast, an individual image or movie may not be divided at all (regardless of possible conversion at operation 420). At operation 430 these individual elements may also be stored separately for later retrieval. Net, at operation 440, the conversion module 140 may generate individual thumbnails for each of the divided elements. As discussed above, these thumbnails may be used for later modification and/or presentation, such as by the content viewer 160 of the publication device 150. At operation 450, the individual elements may be associated together as a combined piece of converted content 113. This may allow later presentation and/or modification of the converted content 113 without requiring the converted content 113 to be processed and split again during publication. Finally, the re-associated piece of converted content 113 may be stored, such as on content storage 101. The process may then end.

Referring now to FIG. 5, an example process 500 for the publisher device 150 to request modification and/or sharing of content from the CPS 100 is illustrated in accordance with various embodiments. While FIG. 5 illustrates particular example operations, in various embodiments, the process may include additional operations, omit illustrated operations, and/or combine illustrated operations. The process may begin at operation 510, where the publisher views the converted content 113, such as at the content viewer 160 of the publisher device 150. In various embodiments, the publisher may obtain access to the content in a variety of ways. For example, the publisher may receive a notification from the CPS 100 that one or more pieces of converted content 113 are available for review, and the publisher may cause the publisher device 150 to download the converted content 113 for review. In some embodiments, the CPS 100 may push the converted content 113 directly to the publishing device for review without requiring action on the part of the publisher to retrieve the converted content 113.

Next, at operation 520, the publisher may make modifications to the content, such as by performing changes to the converted content 113 through the interface of the modification module of the publisher device. Particular examples of modifications, as well as restrictions on modifications, are described above. Next, at operation 530, these modifications may be recorded by the modification interface 170. In various embodiments, the modification may be recorded only as allowed according to permissions associated with the content. These permissions may have been received from the CPS 100 along with delivery of the converted content 113 to the publisher device.

At operation 540, the publisher may select one or more recipients for the content. In various embodiments, this selection may be performed using the sharing interface 180 of the publisher device. In various embodiments, these recipients may be selected individually using individual identifiers such as, for example, a recipient name, title, phone number, and/or email address. In other embodiments, more than one recipient may be selected at once, such as by the publisher selecting a predetermined group, such as a particular set of recipients working at a company or partnership, or a predetermined group of recipients that have similar titles, similar job responsibilities, or similar specialties. Next, at operation 550, these recipient selections may be recorded by the sharing interface 180. In various embodiments, the recipient selections may be recorded by the sharing interface 180 only as allowed according to permissions associated with the content, similar to the recording of modifications. At operation 560, the publisher device may send a sharing request to the CPS 100. This sharing request may, in various embodiments, include one or more indications of modifications that were recorded by the modification interface 170 and/or one or more sharing recipients selected using the sharing interface 180. It may be noted that, in various embodiments, the sharing request may not include modifications and may only include indications of recipients for sharing. In other embodiments, a modification request may be sent by the publisher from the publisher device without requesting immediate sharing. The process may then end.

Referring now to FIG. 6, an example process 600 for the CPS 100 to share stored content is illustrated in accordance with various embodiments. While FIG. 6 illustrates particular example operations, in various embodiments, the process may include additional operations, omit illustrated operations, and/or combine illustrated operations. The process may begin at operation 610, when the CPS 100 may receive a sharing request, such as from the publisher device. Next, at operation 620, the CPS 100 may perform modifications for which instructions were received in the sharing request. In various embodiments, performance of modifications may include removal of content, modification of data, addition of content, and other types of modifications such as those described herein. Next, at operation 620 the CPS 100 may store one or more of the modified content and/or the received modification instructions, such as at content storage 101. In some embodiments, the modified content may be stored so that it may be later shared. In some embodiments, the modification instructions may be stored so that the modified content may be recreated when the need to share the modified content arises. Next, at operation 640, the recipients may be identified from the sharing request, and the modified content may be sent to the recipients at operation 650. In various embodiments, the modified content may be sent directly to the recipients at operation 650. In other embodiments, a message or other data structure may be sent to the recipients to provide for later retrieval of modified content to recipient devices.

It may be noted that, while particular modification and sharing embodiments are illustrated, in some embodiments, other workflows may be performed. For example, In various embodiments, if the request does not contain sharing recipients, only modifications may be made. Similarly, if the request does not contain modifications, the content may be shared without the performance of any modifications. Additionally, in some embodiments, the modification of content and/or the sharing of the content may be performed or not performed as allowed by permissions that have been received by the CPS 100 and associated with the content. Thus, the modification and/or sharing modules 140 and/or 120 may consult with the permissions module to confirm modification and/or sharing before these actions are performed.

Additionally, in some embodiments, modification may be performed locally at the publishing device, and the modified content itself may be sent to the CPS 100 for storage and later sharing, rather than the publisher device sending modification instructions to the CPS 100. Additionally, in some embodiments, sharing may be performed directly from the publishing device, rather than as mediated by the CPS 100 (not illustrated). In various embodiments, the publisher may, as part of the sharing request, send a request to the CPS 100 to check whether there has been a newer piece of content 110 made available by the content provider. In some embodiments as well, the sharing request may include a time and/or date at which the sharing should be performed; the CPS 100 may thus be configured to suspend sharing to a recipient until an appropriate time. Other embodiments may be performed as well.

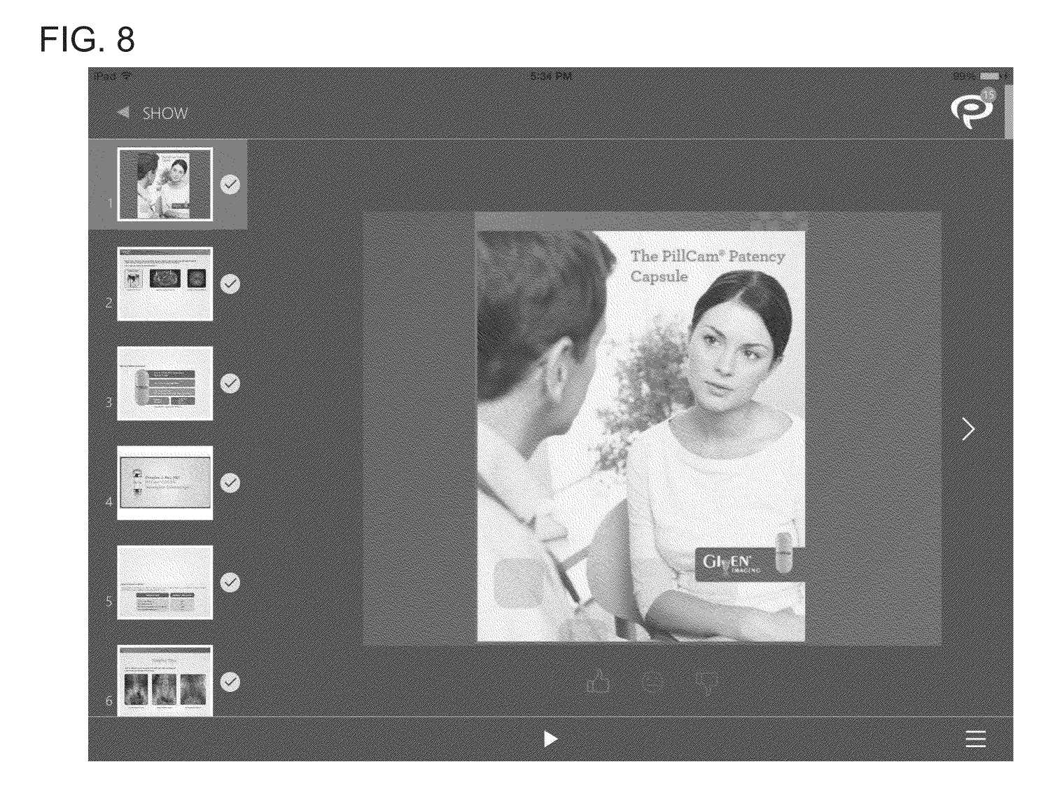

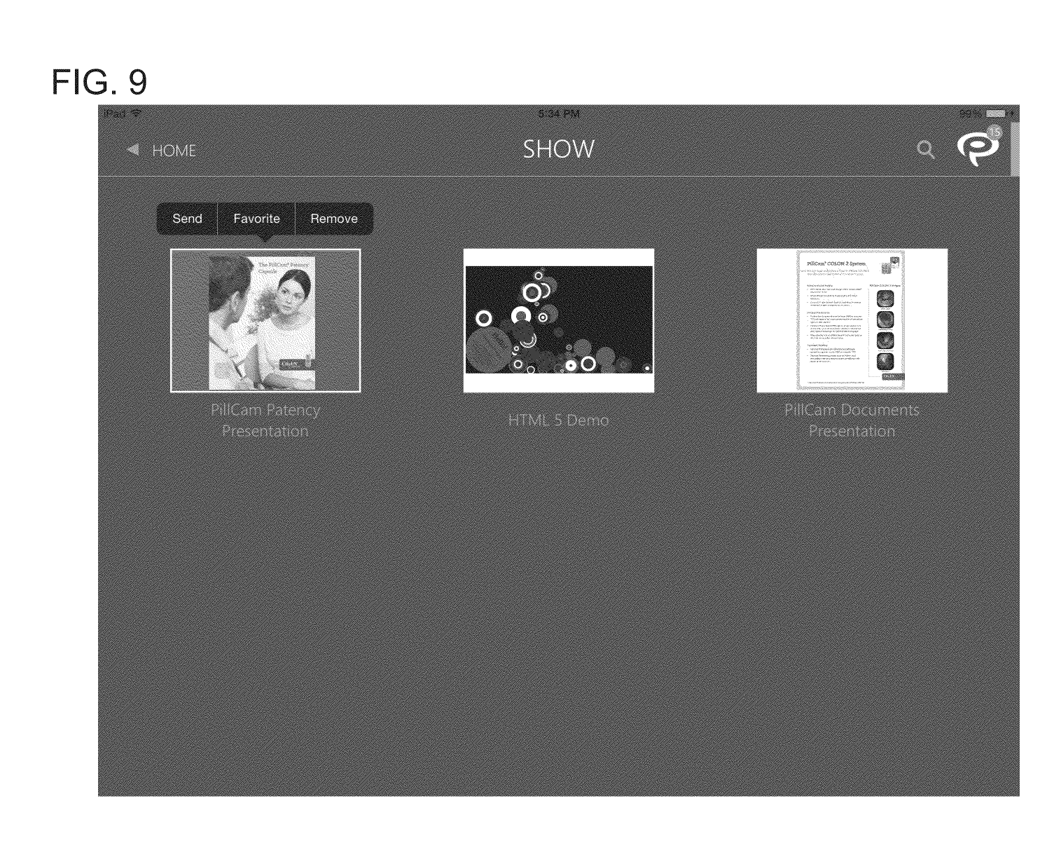

FIGS. 7-14 illustrate example interfaces of a publisher device used to perform some of the techniques described herein. For example, in FIG. 7, an example of the content viewer 160 is shown providing three pieces of content for selection and viewing by a publisher. In various embodiments, these examples may be provided to a publisher in association with thumbnails generated as part of process 400 of FIG. 4. In FIG. 8, the content “PillCam Patency Presentation”, illustrated in FIG. 7, has been selected, which is a presentation. As illustrated in FIG. 8, the publisher may be facilitated in viewing individual slides or pages of the presentation, as well as selecting the individual slides for modification or sharing. At FIG. 9, the content viewer 160 is illustrated as presenting controls for options for activities to be performed with a selected piece of content, including sending the content to a recipient, favoriting the content for easy location at a later time, or removing the content from the publisher device 150.

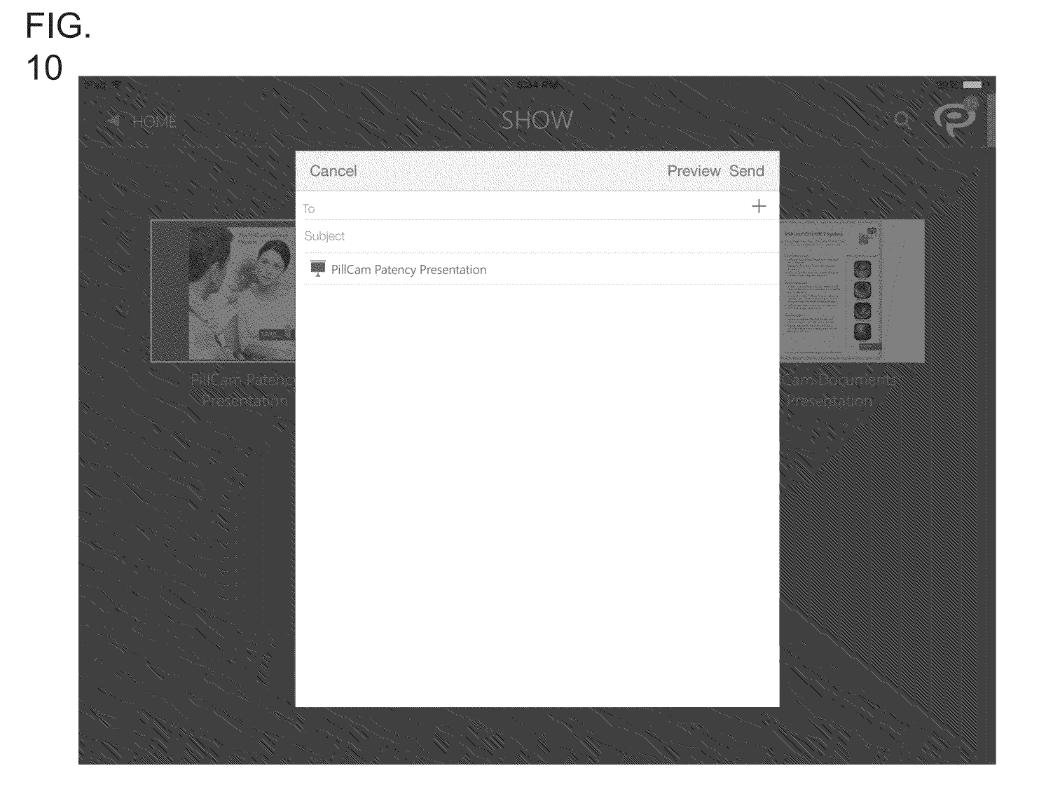

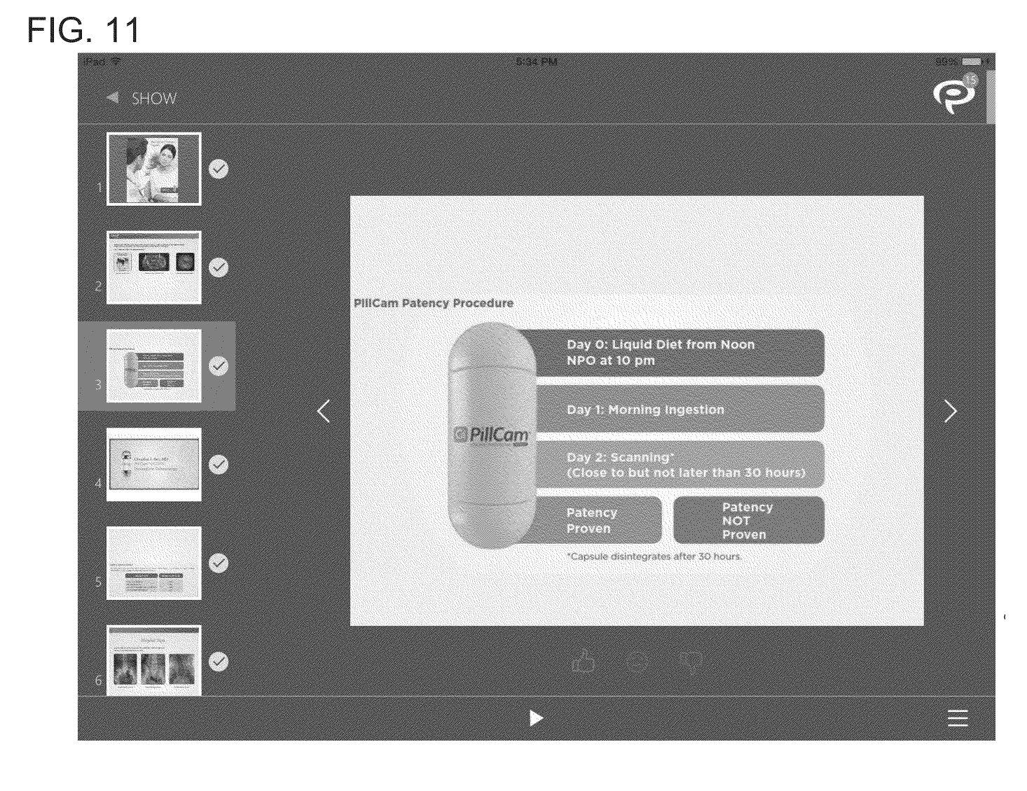

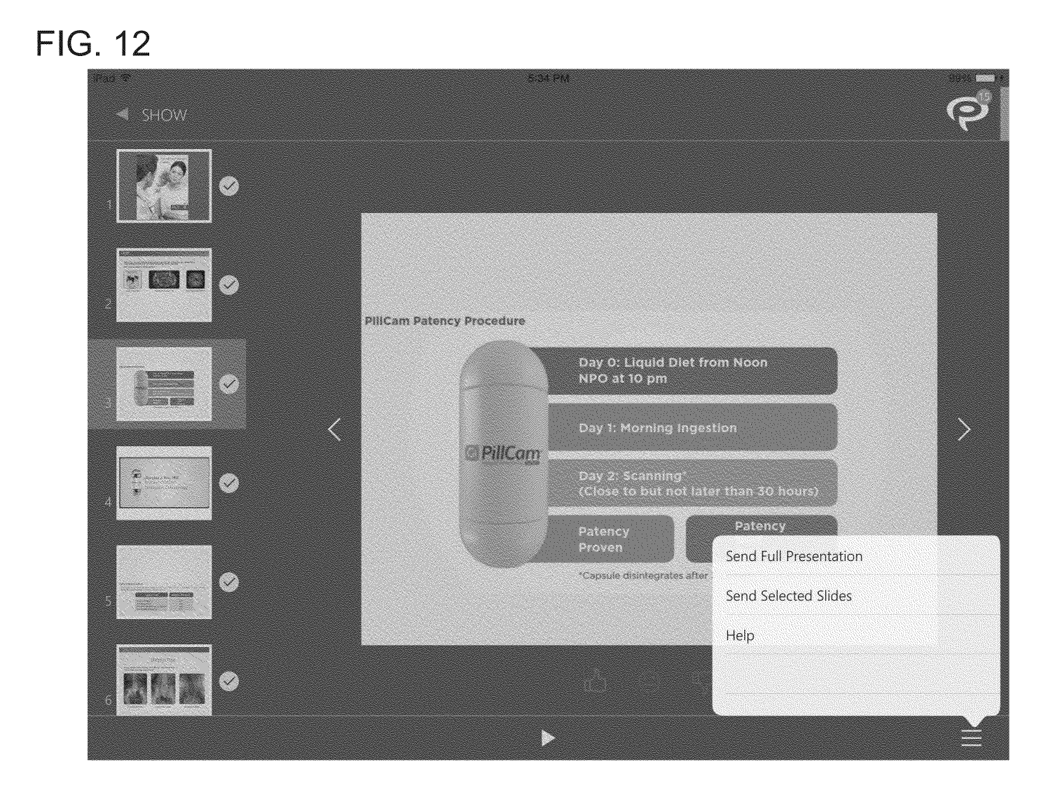

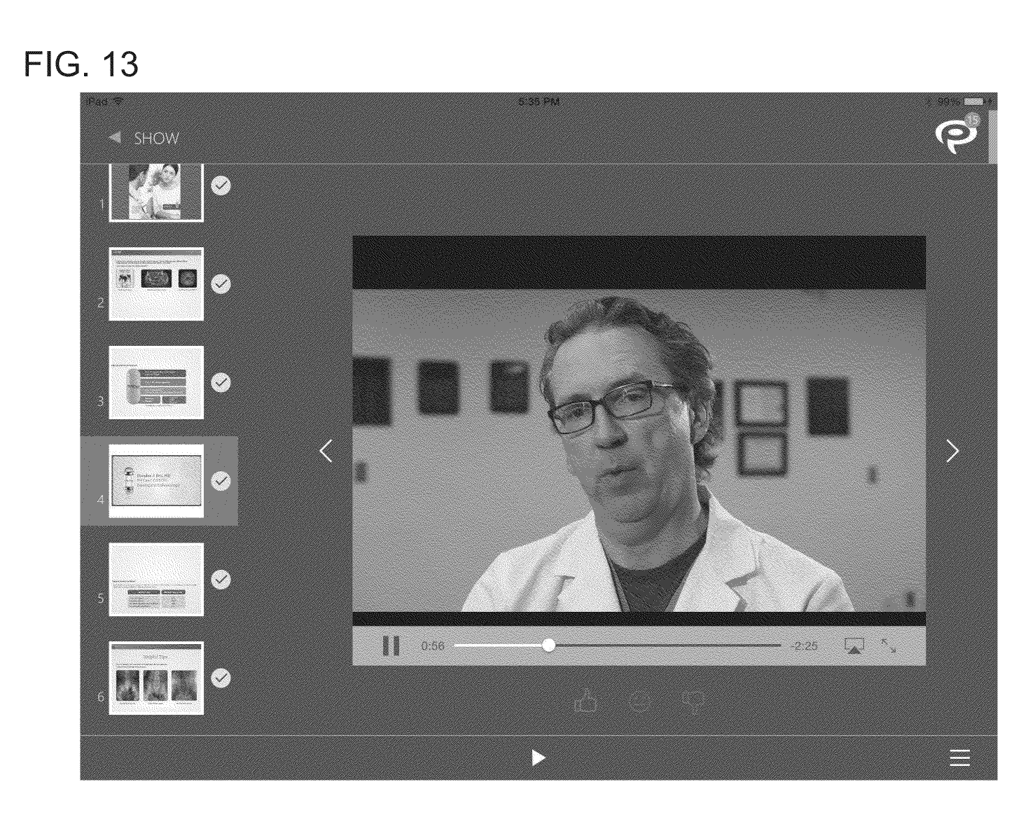

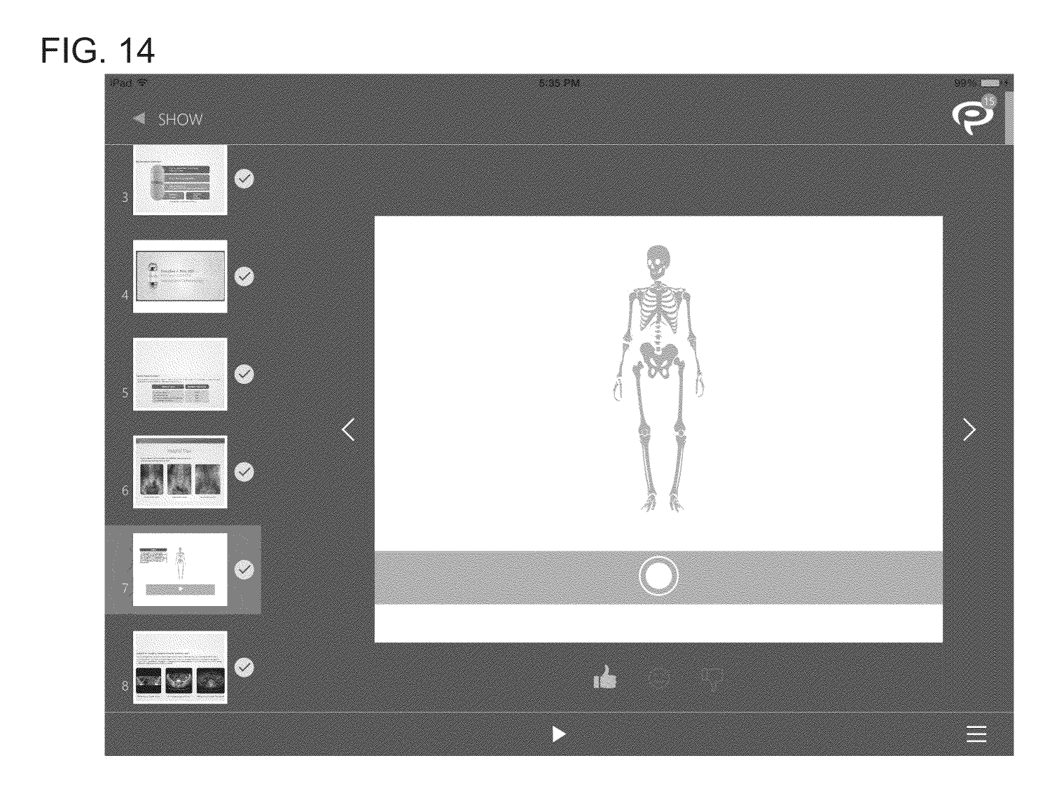

At FIG. 10, an example sharing interface 180 is illustrated. In the example, the publisher may be presented with an interface reminiscent of an email interface, showing the content to be shared as a attachment, and allowing the publisher to identify sharing recipients as well as include text in a subject line or text body. At FIGS. 11 and 12, an example of the modification interface 170 is illustrated, where the publisher may select individual slides, and may elect to share the entire content or selected portions of the content with recipients. At FIGS. 13 and 14, examples of viewing different types of content, including video and models are illustrated. As FIGS. 13 and 14 illustrate, a publisher or recipient may indicate that a particular portion of content is liked or disliked by a viewer of the content. For example, in FIGS. 13 and 14, thumbs up and thumbs down icons are provided for these indications. As mentioned above, this information may be recorded by the content viewer and may be provided back to the CPS 100 for association with the content.

Referring now to FIG. 15, an example computer system suitable for practicing various aspects of the present disclosure, including processes described herein, is illustrated in accordance with various embodiments. As shown, computer 1500 may include one or more processors or processor cores 1502, and system memory 1504. For the purpose of this application, including the claims, the terms “processor” and “processor cores” may be considered synonymous, unless the context clearly requires otherwise. Additionally, computer 1500 may include mass storage devices 1506 (such as diskette, hard drive, compact disc read only memory (CD-ROM), remote storage, and so forth), input/output devices 1508 (such as display, keyboard, cursor control, remote control, gaming controller, image capture device, and so forth) and communication interfaces 1510 (such as network interface cards, modems, infrared receivers, radio receivers (e.g., Bluetooth), and so forth). The elements may be coupled to each other via system bus 1512, which may represent one or more buses. In the case of multiple buses, they may be bridged by one or more bus bridges (not shown) While FIG. 15 illustrates the components as being physically close to one another, in various embodiments, the components may be remotely located from each other in different physical devices or locations.

Each of these elements may perform its conventional functions known in the art. In particular, system memory 1504 and mass storage devices 1506 may be employed to store a working copy and a permanent copy of the programming instructions implementing the operations associated with publishing of managed data as shown in processes described herein. The various elements may be implemented by assembler instructions supported by processor(s) 1502 or high-level languages, such as, for example, C, that can be compiled into such instructions.

The permanent copy of the programming instructions may be placed into permanent storage devices 1506 in the factory, or in the field, through, for example, a distribution medium (not shown), such as a compact disc (CD), or through communication interface 1510 (from a distribution server (not shown)). That is, one or more distribution media having an implementation of the processes described herein may be employed to distribute the programming instructions and program various computing devices.

The number, capability and/or capacity of these elements 1510-1512 may vary, depending on how computer 1500 is used. Their constitutions are otherwise known, and accordingly will not be further described. The various elements may also be configured as part of a system of computing devices.

FIG. 16 illustrates an example least one computer-readable storage medium 1602 having instructions configured to practice all or selections of the operations associated with techniques described herein. As illustrated, least one computer-readable storage medium 1602 may include a number of programming instructions 1604. Programming instructions 1604 may be configured to enable a device, e.g., computer 1500, in response to execution of the programming instructions, to perform, e.g., various operations of processes described herein, but not limited to, to the various operations performed to modify and share content. In alternate embodiments, programming instructions 1604 may be disposed on multiple least one computer-readable storage media 1602 instead.

Referring back to FIG. 15, for one embodiment, at least one of processors 1502 may be packaged together with computational logic 1522 configured to practice aspects of processes described herein. For one embodiment, at least one of processors 1502 may be packaged together with computational logic 1522 configured to practice aspects of processes of described herein to form a System in Package (SiP). For one embodiment, at least one of processors 1502 may be integrated on the same die with computational logic 1522 configured to practice aspects of processes of described herein. For one embodiment, at least one of processors 1502 may be packaged together with computational logic 1522 configured to practice aspects of processes of described herein to form a System on Chip (SoC). For at least one embodiment, the SoC may be utilized in, e.g., but not limited to, a computing tablet, a phone, or other mobile or personal computing device.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method for publishing content, the method comprising:
receiving, by a computing system from a content provider, a piece of content for subsequent publishing to recipient devices;
converting, by the computing system, the piece of content to a converted piece of content for subsequent publishing;
providing, by the computing system, the converted piece of content for viewing on a publishing device;
receiving, by the computing system, identifications of one or more recipients from the publishing device; and
sending, by the computing system, published content based on the converted piece of content to one or more recipient devices associated with the identified recipients, wherein the sending is in compliance with one or more permissions received from the content provider.

2. The method of claim 1, wherein sending in compliance with the one or more permissions comprises sending only to recipients identified in the one or more permissions.

3. The method of claim 1, further comprising receiving, by the computing system, one or more modifications to be performed to the converted piece of content prior to sharing.

4. The method of claim 2, wherein receiving modifications comprises receiving one or more indications of deletions, redactions, additions, filters, and changes to order of elements of the converted piece of content.

5. The method of claim 2, further comprising performing, by the computing system, the one or more modifications prior to sharing.

6. The method of claim 4, wherein performing the one or more modifications comprises performing only modifications which are allowed in the one or more permissions.

7. The method of claim 4, wherein performing the one or more modifications comprises, prior to receipt of the indications of one or more recipients:
performing the modifications in response to receipt of the indications of the modifications to generate modified content; and
storing the modified content.

8. The method of claim 4, wherein performing the one or more modifications comprises:
prior to receipt of the indications of one or more recipients, storing the indications of the modifications; and
in response to receipt of the indications of the recipients, performing the modifications in response to receipt of the indications of the modifications to generate modified content.

9. The method of claim 1, wherein converting the piece of content comprises dividing the piece of content into one or more individual elements.

10. The method of claim 7, wherein the one or more individual elements comprise one or more of individual pages, slides, images, and/or videos.

11. The method of claim 1, wherein converting the piece of content comprises converting one or more images to one or more converted images that have predefined formats and sizes.

12. The method of claim 1, wherein converting the piece of content comprises transcoding one or more videos to one or more converted videos that have predefined formats and sizes.

13. One or more non-transitory computer-readable media containing instructions written thereon that, in response to execution on a computer system causes the computer system to publish content by causing the computer system to:
receive, from a content provider, a piece of content for subsequent publishing to recipient devices;
convert the piece of content to a converted piece of content for subsequent publishing;
provide the converted piece of content for viewing on a publishing device;
receive identifications of one or more recipients from the publishing device; and
send published content based on the converted piece of content to one or more recipient devices associated with the identified recipients, wherein the send is in compliance with one or more permissions received from the content provider.

14. The one or more non-transitory computer-readable media of claim 13, wherein send in compliance with the one or more permissions comprises send only to recipients identified in the one or more permissions.

15. The one or more non-transitory computer-readable media of claim 13, wherein the instructions are further to cause the computing system to:
receive one or more modifications to be performed to the converted piece of content prior to sharing; and
perform the one or more modifications prior to sharing.

16. The one or more non-transitory computer-readable media of claim 15, wherein perform the one or more modifications comprises perform only modifications which are allowed in the one or more permissions.

17. The one or more non-transitory computer-readable media of claim 15, wherein perform the one or more modifications comprises, prior to receipt of the indications of one or more recipients:
perform the modifications in response to receipt of the indications of the modifications to generate modified content; and
store the modified content.

18. The one or more non-transitory computer-readable media of claim 15, wherein perform the one or more modifications comprises:
prior to receipt of the indications of one or more recipients, store the indications of the modifications; and
in response to receipt of the indications of the recipients, perform the modifications in response to receipt of the indications of the modifications to generate modified content.

19. The one or more non-transitory computer-readable media of claim 13, wherein convert the piece of content comprises divide the piece of content into one or more individual elements, the individual elements comprising one or more of individual pages, slides, images, and/or videos.

20. The method of claim 13, wherein convert the piece of content comprises one or more of: convert one or more images to one or more converted images that have predefined formats and sizes and transcode one or more videos to one or more converted videos that have predefined formats and sizes.

21. An apparatus for publishing content, the apparatus comprising:
one or more computer-readable media;
one or more computer-implemented modules to operate on the one or more computer-readable media to:
receive, from a content provider, a piece of content for subsequent publishing to recipient devices;
convert the piece of content to a converted piece of content for subsequent publishing;
provide the converted piece of content for viewing on a publishing device;
receive identifications of one or more recipients from the publishing device; and
send published content based on the converted piece of content to one or more recipient devices associated with the identified recipients, wherein the send is in compliance with one or more permissions received from the content provider.

22. The apparatus of claim 21, wherein send in compliance with the one or more permissions comprises send only to recipients identified in the one or more permissions.

23. The apparatus of claim 21, wherein the one or more modules are further to:
receive one or more modifications to be performed to the converted piece of content prior to sharing; and
perform the one or more modifications prior to sharing.

24. The apparatus of claim 21, wherein perform the one or more modifications comprises perform only modifications which are allowed in the one or more permissions.

25. The apparatus of claim 21, wherein perform the one or more modifications comprises, prior to receipt of the indications of one or more recipients:
perform the modifications in response to receipt of the indications of the modifications to generate modified content; and
store the modified content.

26. The apparatus of claim 21, wherein perform the one or more modifications comprises:
prior to receipt of the indications of one or more recipients, store the indications of the modifications; and
in response to receipt of the indications of the recipients, perform the modifications in response to receipt of the indications of the modifications to generate modified content.
